(19) United States
(12) Patent Application Publication
(10) Pub. No.: US 2021/0058677 A1
(43) Pub. Date: Feb. 25, 2021

(54) PERSONAL MEDIA CONTENT RETRIEVAL

(71) Applicant: Hewlett-Packard Development Company, L.P., Spring, TX (US)

(72) Inventors: Mithra Vankipuram, Palo Alto, CA (US); Rafael Ballagas, Palo Alto, CA (US); Alexander Thayer, Palo Alto, CA (US)

(21) Appl. No.: 17/049,430

(22) PCT Filed: Sep. 28, 2018
(86) PCT No.: PCT/US2018/053386

§ 371 Date: Oct. 21, 2020

(51) Int. Cl. H04N 21/4788; H04N 21/442; H04N 21/45; H04N 21/422

(52) U.S. Cl. CPC H04N 21/4788; H04N 21/42203; H04N 21/4532; H04N 21/44218

(57) ABSTRACT

A non-transitory media having machine-readable instructions stored thereon is provided. The instructions include a context analyzer to determine context data based on information shared between participants as part of a communications session. An emotion detector detects an emotional state of a given participant of the communications session and generates a media request based on the detected emotional state and the context data, wherein a representation of personal media content is provided to at least one of the participants based on the media request.

### BACKGROUND

A standard communications session often involves two people communicating over wireless technologies such as cell phones. Other types of communications sessions involve conferencing that may be used as an umbrella term for various types of online collaborative services including web seminars (“webinars”), webcasts, and peer-level web meetings. Such meetings can also be conducted over the phone with available wireless cell-phone technologies. Conferencing may also be used in a narrow sense to refer only to the peer-level meeting context, in an attempt to differentiate it from other types of collaborative sessions. In general, communications sessions of differing types are made possible by various communications technologies and protocols. For instance, services may allow real-time point-to-point communications as well as multicast communications from one sender to many receivers. It offers data streams of text-based messages, voice and video chat to be shared concurrently, across geographically dispersed locations. Communications applications include meetings, training events, lectures, or presentations from a web-connected computer to other web-connected computers. Most conferencing, however, is conducted between users over their cell-phones where communications are for mostly personal reasons.

### BRIEF DESCRIPTION OF THE DRAWINGS

FIG. 1 illustrates an example of a non-transitory medium for personal media content retrieval.

FIG. 2 illustrates an example of an emotion detector and search function for personal media content retrieval.

FIG. 3 illustrates an example of a user interface for personal media content retrieval.

FIG. 4 illustrates an example device for personal media content retrieval.

FIG. 5 illustrates an example method for personal media content retrieval.

FIG. 6 illustrates an example of a device and user interface display for personal media content retrieval.

### DETAILED DESCRIPTION

This disclosure relates to retrieval of personal media content for participants of a communications session (e.g., bi-directional communications), such as relating to past memories and experiences of the participants. Such memories stored as personal media content can be retrieved based on a determined context and emotional states detected during communications between participants. A user interface is provided to present media content and enable user interaction with devices and methods executing thereon during the communications session. For example, the user interface can be executed on a device such as a cell phone or laptop computer for example. In this way, one or more participants is provided personal media content (in real-time or near real-time) that is directly relevant to the ongoing communications session without having to stop or pause the session and conduct a manual search.

As an example, an emotion detector can be implemented (e.g., as instructions executable by a processor or processors) to determine an emotional state of a given participant of the session to enable media retrieval. For example, the emotion detector can include an emotion recognizer and emotion analyzer. The emotion recognizer detects emotional state parameters from participants of the communications session, such as can be detected from audio and/or video data that is communicated as part of the session. For example, the emotional state parameters can include voice inflections, voice tones, silent periods, facial patterns, pupil dilation, eye movements, hand movements, or body movements.

A context analyzer, operating with the emotion recognizer, determines context data based on information shared between the participants during the communications session such as may include voice-recognized data specifying dates, times as well names of people, things and locations. The emotion analyzer processes the emotional state parameters and the context data. The emotion analyzer determines a probability (e.g., a confidence value) that a given participant has a predetermined emotional state (e.g., happy, sad, bored) during the communications session with respect to the context data. The emotion analyzer thus generates a media request if the emotional state probability exceeds a threshold (e.g., probability threshold indicating a given emotional state). A search function retrieves personal media content from a datastore that is associated with at least one of the participants based on the media request and provides the personal media content to the user interface.

The personal media content can be represented as a graphical user interface (GUI) icon on the user interface. Such GUI icons, for example, can be implemented as executable instructions stored in non-transitory storage media to render various shapes and sizes of interactive GUI elements that represent the retrieved personal media. The GUI thus can present a user-interactive representation of the personal media content such as in the form of a thumbnail, high-resolution images, annotated graphical images, or animated graphical representations. Examples of personal media content include images, audio files, audio/video files, text files, and so forth. A sharing function can be selected (e.g., in response to a user input) via the GUI icon to activate a sharing function to control sharing the retrieved personal media content when the displayed personal media content is selected by the participants. For example, the sharing function can include executable program code to invoke a print option, a save option, a social media posting option, a text message option, or an e-mail option to enable the participants to share the personal media content with others. The GUI can also be selected to execute other functions, such as can include an editing option that allows a user to filter, add content, or alter the retrieved personal media content.

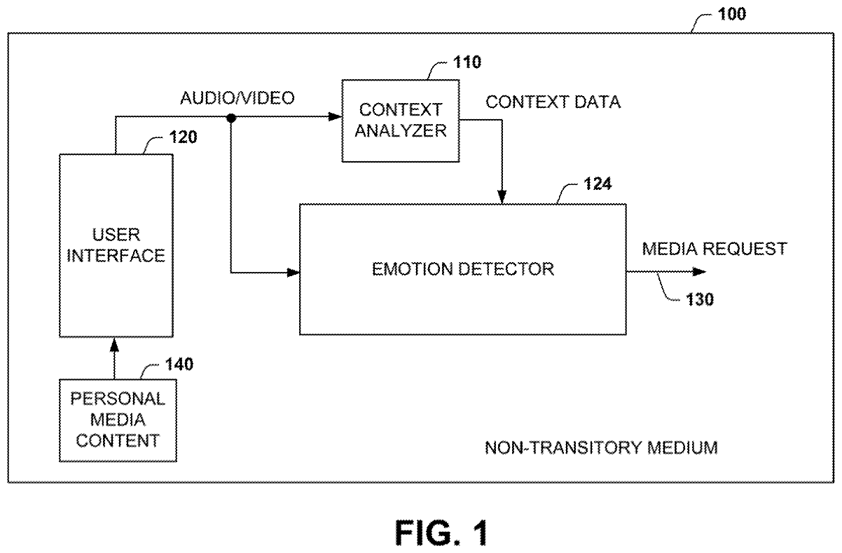

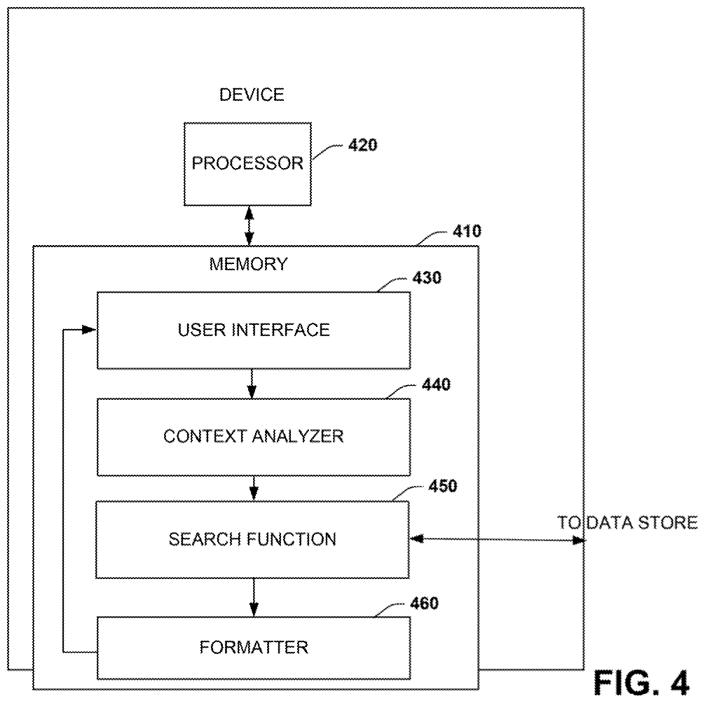

FIG. 1 illustrates an example of a non-transitory medium 100 for personal media content retrieval. As used herein, the term non-transitory medium can include any type of computer memory including random access memory (RAM), read only memory (ROM), remote or virtual memory (e.g., via the Internet), and combinations thereof. The non-transitory medium 100 includes machine-readable instructions stored thereon, which are executable by a processor (see e.g., FIG. 4). A context analyzer 110, which are executable instructions, receives audio and/or video data from a communications stream (e.g., audio and/or video communications). For example, the medium receives the audio/video data by monitoring such data in a communications interface of user device (e.g., a speaker and/or camera of a cell phone or personal computer interface). The context analyzer 110 determines context data based on information shared between participants as part of a communications session. The context data represents a date, person, time and/or place of a prior experience involving at least one of the participants to the session.

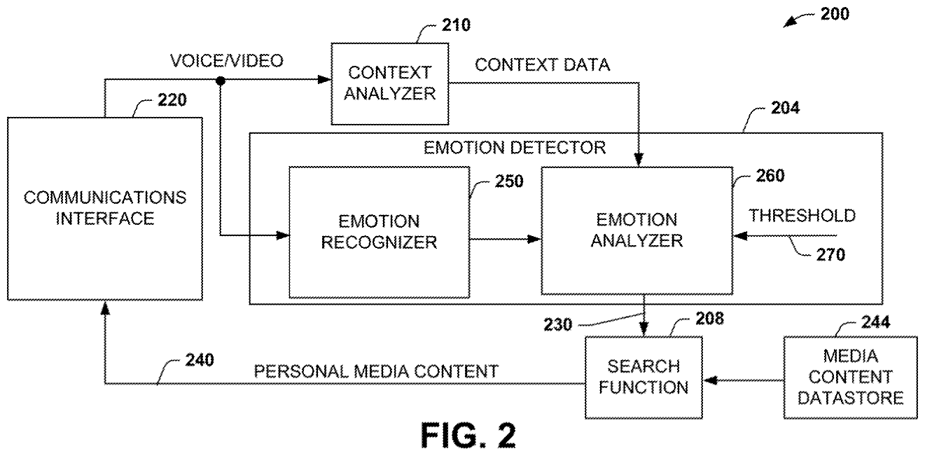

An emotion detector 124, which is implemented as executable instructions, detects an emotional state of a given participant of the communications session and generates a media request 130 based on a detected emotional state and the context data. A representation of personal media content 140 is provided to at least one of the participants based on the media request 130. For example, the representation can include an image that is displayed to one of the participants and/or can include another tangible representation, such as a printed version (e.g., a photograph) of the personal media content 140 that is retrieved. As will be described below with respect to FIG. 2, the emotional state can be determined based on analyzing communications patterns, assigning a probability to the patterns, and generating the media request 130 if the probability exceeds a threshold (e.g., indicating that at least a minimum confidence has been met for the emotional state). In this manner, media content searches can be focused on retrieval of items that are highly personal and likely to invoke pertinent memories of past experiences between participants to the session. A user interface 120 is associated with at least one of the participants to present personal media content 140 that is retrieved based on the media request 130. The personal media content 140 can be an image, an audio file, an audio/video file, and/or a text file, for example.

In an example, the non-transitory medium 100 can be executed as part of a system having a video chat with a touch screen for the user interface 120. Other peripherals can be connected to the system such as a printer or storage device. The system can listen (e.g., via voice recognition program code executing on the device or remotely) for a key word—for example “Remember when . . . ” to information (e.g., derived from context and/or emotional data) about a past memory between participants. Relevant information might include location, rough time, time of day, venue information and people who were part of the event. With this information the system can retrieve photos from a datastore (or datastores) that is associated with the user, such as a local memory of the device executing the non-transitory medium 100 or remote storage (e.g., the user's cloud storage, such as a public and/or private cloud storage system for photo storage, video storage or other cloud system where the user stores media). The user can then choose a sharing function such as for printing out a memorable photo that has been retrieved (e.g., on a local or remote printer, such as cloud print application). The system can respond to more than one keyword that is extracted from the audio/video data during the communications session.

In some examples, the emotion detector 124 is configured to employ facial and/or gesture recognition as part of the emotion recognition process, such as based on video data during the communication session. As mentioned, recognized facial expressions and/or gestures can be utilized to determine an emotional state used to implement retrieval of personal media content. With access to social media information, the retrieval process can be utilized to retrieve socially relevant personal media content—matching photos using facial recognition to profile photos of people mentioned. In addition to display, if there are many retrieved photos, the user can employ user interface touch-screen gestures to scroll through photos and select from a plurality of sharing options by touching graphical icons representing the retrieved information and as will be described below.

FIG. 2 illustrates an example of an emotion detector (e.g., corresponding to emotion detector 124) 204 and search function 208 for personal media content retrieval. A context analyzer 210 receives audio/video data from a communications interface 220 and determines context data based on information shared between participants as part of a communications session. The emotion detector 204 detects an emotional state of a given participant of the communications session and generates a media request 230 based on the detected emotional state and the context data. The communications interface 220 is associated with at least one of the participants (e.g., on a display of a computing device, such as smart phone or other device) to present personal media content 240 that is retrieved by the search function 208 based on the media request 230. A local and/or remote media content datastore 244 (or data stores) can be searched by the search function 208 in response to the media request 230.

The emotion detector 204 includes an emotion recognizer 250 to detect emotional state parameters based on data communicated between the participants of the communications session. For example, the emotional state parameters can include voice inflections, voice tones, silent periods, facial patterns, pupil dilation, eye movements, hand movements and/or body movements that can indicate a given emotional state of a user. An emotion analyzer 260 processes the emotional state parameters and the context data from the context analyzer 210. The emotion analyzer 260 determines a probability of the emotional state of the given participant of the communications session with respect to the context data and generates the media request 230 in response to the probability exceeding a threshold 270. In one example, audio and/or video can be analyzed by artificial intelligence (AI) instructions to assign probabilities (e.g., confidence or likelihood value) to a detected emotional state or multiple such states. In one example, the AI instructions can be implemented by a classifier such as a support vector machine (SVM).

As mentioned, the context data from the context analyzer 210 can represent a date, person, time and/or place that is derived from audio and/or video recognition of the communications data. For example, the context data may represent a prior experience involving the participants to the communications session. The search function (e.g., instructions to search a database) 208 can execute a search of datastores 244 based on the context data to retrieve the personal media content 240. The datastores 244 may include personal storage (e.g., local and/or remote non-transitory storage media) that is associated with at least one of the participants. The search function 208 provides the personal media content 240 to the communications interface 220 based on the media request 230. The personal media content 240 can be stored on the datastore with metadata that includes or is a semantic equivalent to emotional metadata tags or context metadata tags determined by the emotion detector 204 and context analyzer 210, respectively. The search function 208 can match the at least one of the emotional or context metadata tags matched with the determined emotional state and context data to retrieve the personal media content 240.

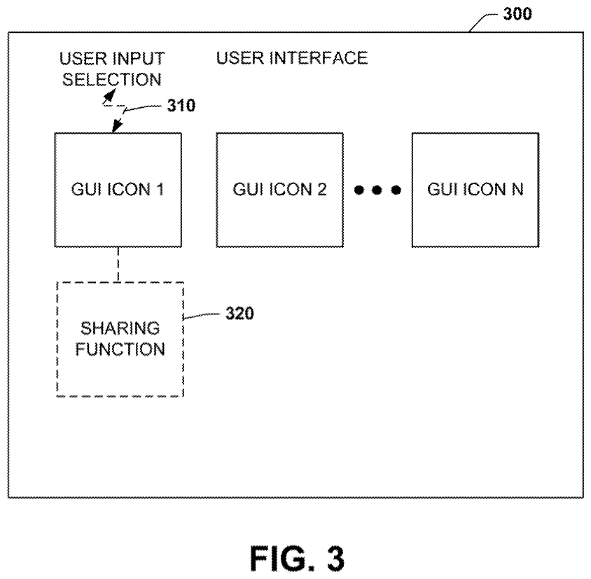

FIG. 3 illustrates an example of a user interface 300 for personal media content retrieval. In this example, formatter instructions (e.g., executable instructions stored in computer-readable media) generate graphical user interface (GUI) icons 310, shown as GUI icon 1 through N, with N being a positive integer. The GUI icons 310 graphically represent the personal media content on the user interface, wherein the personal media content is an image, an audio file, an audio/video file, or a text file. In an example, the GUI icons 1-N can be presented as thumbnail image of a retrieved image, audio file, or text file. The GUI icons 1-N can be associated with a sharing function. For example, if one of the participants hovers a pointing element (e.g., cursor) over a given GUI, such as shown at GUI_1, a user input selection (e.g., via double-click or user input) can be implemented to activate a sharing function (or functions), such as shown at 320. The sharing function 320 can be provided to the participant in response to the selection.

For example, the sharing function 320 can be activated to enable sharing of the retrieved personal media content described herein in response to the GUI being selected by a user input such as shown at 310. The sharing function can be activated by executing instructions that associate the GUI icon with a list of predetermined automated actions such as printing actions, saving/storage actions, e-mail generation, text message generation, and so forth. The automated actions assigned to the GUI icon can be edited by a given user by entering an e-mail addresses, cell phone numbers, social media pages, and so forth where retrieved content may be further shared. By way of example, the sharing function 320 can include at least one of a print option, a save option, a social media posting option, a text message option, or an e-mail option. In another example, the sharing function 320 can include an editing option to enable participants to filter, add content, or alter the retrieved personal media content in response to user input.

FIG. 4 illustrates an example device 400 for personal media content retrieval. The device 400 includes a non-transitory memory 410 to store data and machine-readable instructions. A processor 420 is configured to access the non-transitory memory 410 and execute the instructions. The instructions include a user interface 430 to enable user interaction with the device as part of communications between participants of a communications session as described herein. The instructions also include a context analyzer 440 to determine context data based on information shared between participants during the communications session and to determine if a media request should be generated. The instructions also include a search function 450 to retrieve personal media content from a datastore of at least one of the participants based on the context data and the media request. The user interface 430 is associated with the device 400 of at least one of the participants is configured to present the personal media content that is retrieved by the search function. The instructions also include a formatter 460 to format the personal media content as a graphical user interface (GUI) icon on the user interface 430. The GUI icon includes a sharing function that is invoked in response to user input to enable sharing of the personal media content. For example, the sharing function can include or activate executable instructions to at least one of a print option, a save option, a social media posting option, a text message option, or an e-mail option to allow the participants to share the personal media content with other users in response to user input.

In another example, the sharing function includes or activates executable instructions to implement an editing option to allow users to filter, add content, or alter the retrieved personal media content in response to user input. Although not shown, instructions can be provided in the non-transitory memory 410 for an emotion detector to detect an emotional state of a given participant of the communications session and to generate a media request that is used by the search function 450 to retrieve the personal media content based on the detected emotional state and the context data. As noted previously (e.g., FIG. 2), the emotion detector can include an emotion recognizer to detect given emotional patterns from gestures and emotion analyzer to generate a media request if the probability of a detected emotional state exceeds a threshold.

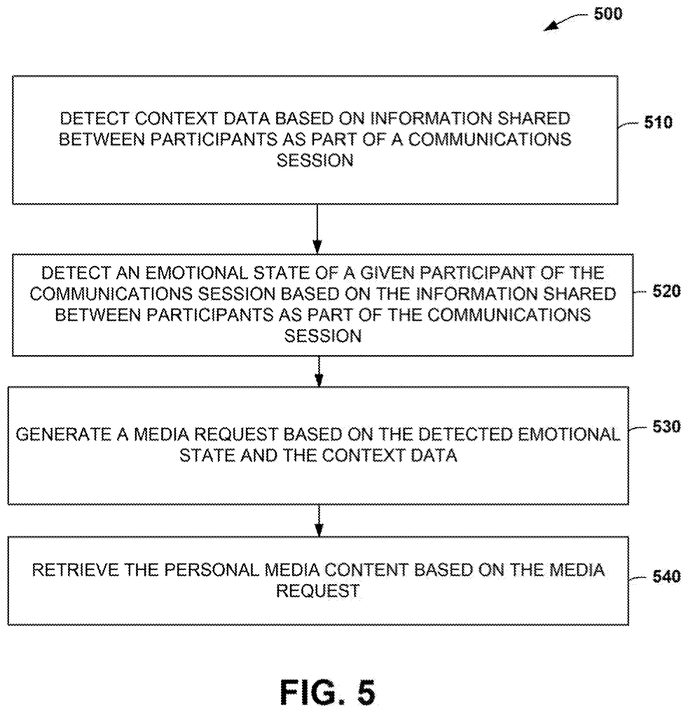

In view of the foregoing structural and functional features described above, an example method will be better appreciated with reference to FIG. 5. While, for purposes of simplicity of explanation, the method is shown and described as executing serially, it is to be understood and appreciated that the method is not limited by the illustrated order, as parts of the method could occur in different orders and/or concurrently from that shown and described herein. Such method can be executed by various components configured as machine-readable instructions stored in a non-transitory media and executable by a processor (or processors), for example.

FIG. 5 illustrates an example method 500 for personal media content retrieval. At 510, the method 500 includes detecting context data based on information shared between participants as part of a communications session. At 520, the method 500 includes detecting an emotional state of a given participant of the communications session based on the information shared between participants as part of the communications session. At 530, the method 500 includes generating a media request based on the detected emotional state and the context data. At 540, the method 500 includes retrieving the personal media content based on the media request. Although not shown, the method 500 can include formatting the personal media content as a graphical user interface (GUI) icon on a user interface. This can include providing a sharing function with the GUI icon for the retrieved personal media content in response to user input. The sharing function can include at least one of a print option, a save option, a social media posting option, a text message option, an e-mail option, or an editing option to allow the participants to share the personal media content with others in response to user input.

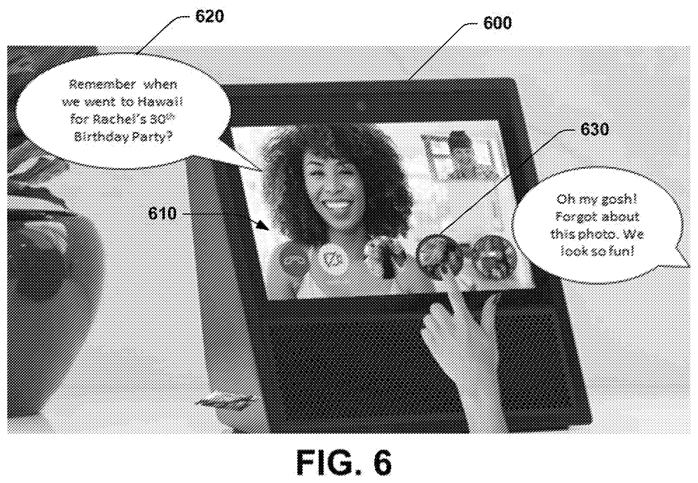

FIG. 6 illustrates an example of a device 600 and user interface 610 for personal media content retrieval. The user interface 610 allows for exchanges of audio and visual information as shown. An audio snippet is shown at 620 where one of the participants begins a phrase such a “Remember when . . . ” which triggers a personal media content retrieval as described herein. A circular GUI icon is displayed at 630 (other shapes are possible) showing an image that is retrieved in response to the triggered detection by the device 600. As shown, the GUI icon 630 can be touched by the user to activate various sharing functions such as increasing the size of the image (over the thumbnail view of the icon), print options, save options, social media posting options, texting options, e-mail options and so forth in which to distribute the image that was recovered based on the detected context and/or emotional state of the participants.

What has been described above are examples. One of ordinary skill in the art will recognize that many further combinations and permutations are possible. Accordingly, this disclosure is intended to embrace all such alterations, modifications, and variations that fall within the scope of this application, including the appended claims. Additionally, where the disclosure or claims recite “a,” “an,” “a first,” or “another” element, or the equivalent thereof, it should be interpreted to include one such element and neither requiring nor excluding two or more such elements. As used herein, the term “includes” means includes but not limited to, and the term “including” means including but not limited to. The term “based on” means based at least in part on.

What is claimed is:

1. A non-transitory medium having machine-readable instructions stored thereon, the instructions comprising:
a context analyzer to determine context data based on information shared between participants as part of a communications session; and
an emotion detector to detect an emotional state of a given participant of the communications session and to generate a media request for personal media content based on the detected emotional state and the context data, wherein a representation of the personal media content is provided to at least one of the participants based on the media request.

2. The medium of claim 1, wherein the emotion detector further comprises:
an emotion recognizer to detect emotional state parameters based on data communicated between the participants of the communications session; and
an emotion analyzer to process the emotional state parameters and the context data, the emotion analyzer to determine a probability of the emotional state of the given participant of the communications session with respect to the context data and to generate the media request in response to the probability exceeding a threshold and the context data.

3. The medium of claim 1, wherein the instructions further comprise a user interface associated with at least one of the participants to present the personal media content that is retrieved based on the media request, the user interface including a graphical user interface (GUI) icon to graphically represent the personal media content on the user interface, wherein the personal media content is an image, an audio file, an audio/video file, or a text file.

4. The medium of claim 3, wherein the instructions further comprise a sharing function associated with the GUI icon, the sharing function being activated to enable sharing of the personal media content in response to the GUI being selected by a user input, wherein the sharing function includes at least one of a print option, a save option, a social media posting option, a text message option, or an e-mail option.

5. The medium of claim 4, wherein the sharing function includes an editing option to enable participants to filter, add content, or alter the retrieved personal media content in response to user input.

6. The medium of claim 1, wherein the context data represents a date, time, and/or place of a prior experience involving at least one of the participants.

7. The medium of claim 1, wherein the emotional state parameters include voice inflections, voice tones, silent periods, facial patterns, pupil dilation, eye movements, hand movements and/or body movements.

8. The medium of claim 1, wherein the instructions further comprise a search function to retrieve the personal media content from a datastore that is associated with at least one of the participants and to provide the personal media content to at least one of the participants based on the media request.

9. The medium of claim 8, wherein the personal media content is stored on the datastore with metadata that includes at least one of emotional metadata tags or context metadata tags, the search function matching the at least one of the emotional or context metadata tags matched with the determined emotional state and context data to retrieve the personal media content.

10. A device, comprising:
a non-transitory memory to store data and instructions; and
a processor configured to access the memory and execute the instructions; the instructions comprising:
a context analyzer to determine context data based on information shared between participants during a communications session;
a search function to retrieve personal media content from a datastore of at least one of the participants based on the context data;
a user interface associated with at least one of the participants to present the personal media content that is retrieved; and
a formatter to format the personal media content as a graphical user interface (GUI) icon on the user interface, wherein the GUI icon includes a sharing function that is invoked in response to user input to enable sharing of the personal media content.

11. The device of claim 10, wherein the sharing function includes at least one of a print option, a save option, a social media posting option, a text message option, or an e-mail option to allow the participants to share the personal media content with other users in response to user input.

12. The device of claim 10, wherein the sharing function includes an editing option to allow users to filter, add content, or after the retrieved personal media content in response to user input.

13. The device of claim 10, further comprising an emotion detector to detect an emotional state of a given participant of the communications session and to generate a media request that is used by the search function to retrieve the personal media content based on the detected emotional state and the context data.

14. A method, comprising:
detecting context data based on information shared between participants as part of a communications session;
detecting an emotional state of a given participant of the communications session based on the information shared between participants as part of the communications session;
generating a media request for personal media content based on the detected emotional state and the context data; and
retrieving the personal media content based on the media request.

15. The method of claim 14, further comprising:
formatting the personal media content as a graphical user interface (GUI) icon on a user interface; and
providing a sharing function with the GUI icon for the retrieved personal media content in response to user input, wherein the sharing function includes at least one of a print option, a save option, a social media posting option, a text message option, an e-mail option, or an editing option to allow the participants to share the personal media content with others in response to user input.
